(19) United States
(12) Patent Application Publication
(10) Pub. No.: US 2014/0368069 A1
(43) Pub. Date: Dec. 18, 2014

(54) ELECTRIC CONNECTOR CAPABLE OF SELECTING A TYPE OF ENGAGEMENT, AND ELECTRIC MOTOR INCLUDING THE SAME

(71) Applicant: FANUC CORPORATION, Yamanashi (JP)

(72) Inventor: Gang Ren, Yamanashi (JP)

(21) Appl. No.: 14/301,581

(22) Filed: Jun. 11, 2014

(30) Foreign Application Priority Data
Jun. 12, 2013 (JP) 2013-124017

(51) Int. Cl. H01R 13/625; H01R 13/622; H02K 11/00

(52) U.S. Cl. CPC H01R 13/625; H02K 11/0094; H01R 13/622
USPC 310/71; 439/337

(57) ABSTRACT

An electric connector that is connectable to other connectors by many types of connection while waterproofing of the electric connector is maintained. The electric connector includes a connection holding part configured to hold a connection state with another connector by each of a plurality of types of engagement. The connection holding part includes a plurality of sections sectionalized in a relative moving direction for electrically connecting the electric connector to another connector. Each of the plurality of sections includes an engaging part corresponding to one of the types of engagement different from one another.

### BACKGROUND ART

1. Field of the Invention

The present invention relates to an electric connector connectable to other connectors by a plurality of types of engagement, and an electric motor including the electric connector.

2. Description of the Related Art

An electric connector connectable to other connectors by both bayonet locking and screwing is known (e.g., Japanese Laid-open Patent Publication No. 2006-236777).

In the electric connector described in Patent Literature 1, a male thread is formed over the entire area of a cylindrical part engaged with the other connectors, and a groove for a bayonet lock is formed in a part of the male thread.

According to the conventional electric connector described above, it is difficult to handle connectors of yet another type of engagement. In addition, when the electric connector is connected to a bayonet lock connecter, a gap is formed between a valley of the male thread of the electric connector and an inner surface of the counterpart connector. Consequently, securing sealing in a connection part is difficult.

The present invention provides an electric connector connectable to other connectors by many types of engagement while waterproofing is maintained in a connection part of the electric connector.

### SUMMARY OF THE INVENTION

According to a first aspect of the present invention, an electric connector includes a connection holding part configured to be able to hold a connection state with another connector by each of a plurality of types of engagement. The connection holding part includes a plurality of sections sectionalized along a relative moving direction for electrically connecting the electric connector to another connector. Each of the plurality of sections includes an engaging part corresponding to one of the types of engagement different from one another.

The connection holding part may be sectionalized into a first section disposed on a distal side of the connection holding part and a second section disposed adjacent to the first section on a proximal side of the connection holding part. In this case, the first section may include a groove extending from a distal end surface of the connection holding part on its outer surface. The second section may include a helically extending male thread on its outer surface.

The first section may be connectable to a connector including an inward projection by bayonet locking. Alternatively, the first section may be connectable to a connector including a movable projection by push-on locking. The second section may be connectable to a connector including a female thread in an inner surface by engagement.

A plurality of grooves may be formed at equal intervals in a circumferential direction of the connection holding part. The groove may include a moving direction groove extending from the end surface of the distal side of the connection holding part toward the proximal side of the connection holding part in the relative moving direction, and a circumferential direction groove extending from a proximal end of the moving direction groove in a circumferential direction.

The moving direction groove may be formed so as to have narrower and narrower width toward the proximal side of the connection holding part from the end surface of the distal side of the connection holding part. According to a second aspect of the present invention, an electric motor includes the aforementioned electric connector.

### BRIEF DESCRIPTION OF THE DRAWINGS

The above and other objects, features and advantages of the present invention will become more apparent from the following description of the preferred embodiments with reference to the attached drawings, in which:

FIG. 1 is a schematic diagram illustrating an electric motor according to an embodiment of the present invention;

FIG. 2 is a perspective view illustrating an electric connector according to an embodiment of the present invention;

FIG. 3 is a side view of the electric connector illustrated in FIG. 2;

FIG. 4 is a diagram illustrating a method for connecting the electric connector illustrated in FIG. 2 to another connector by push-on locking;

FIG. 5 is a diagram illustrating a method for connecting the electric connector illustrated in FIG. 2 to another connector by screwing;

FIG. 6 is a perspective view illustrating an electric connector according to another embodiment of the present invention;

FIG. 7 is a side view of the electric connector illustrated in FIG. 6; and

FIG. 8 is a diagram illustrating a method for connecting the electric connector illustrated in FIG. 6 to another connector by bayonet locking.

### DETAILED DESCRIPTION

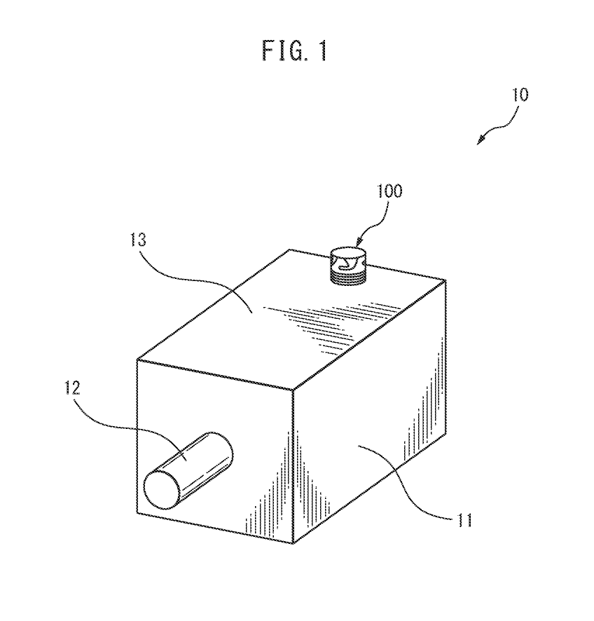

Hereinafter, the embodiments of the present invention will be described in detail with reference to the drawings. First, referring to FIG. 1, a configuration of an electric motor 10 according to an embodiment of the present invention will be described. The electric motor 10 is an electrically controllable motor such as a servo motor.

The electric motor 10 includes a housing 11, a stator (not illustrated) fixed in the housing 11, and a rotor (not illustrated) rotatably installed in a diameter-direction inside of the stator. A rotary shaft 12 for outputting a rotational force to the outside is fixedly installed in the rotor.

An electric connector 100 is attached to a top surface 13 of the housing 11 of the electric motor 10. The electric connector 100 is electrically connected to a connector of an external device so that power can be input to the electric motor 10 from the external device such as a power source.

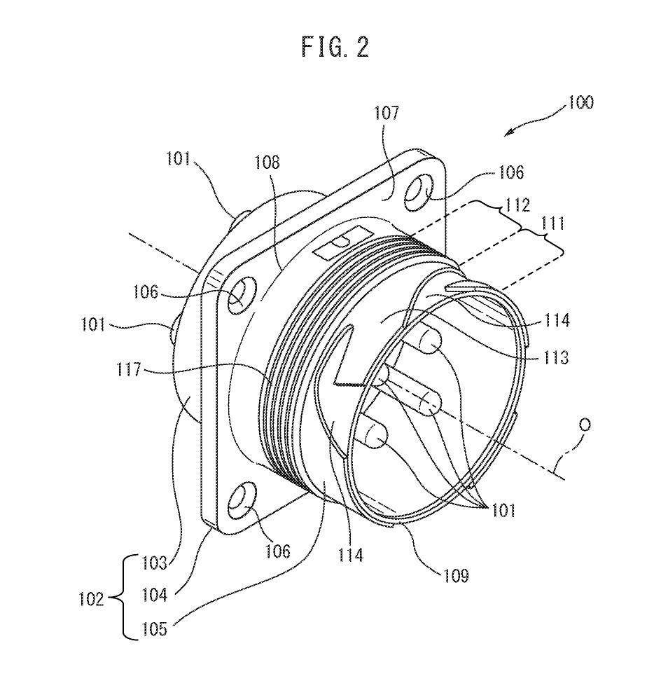

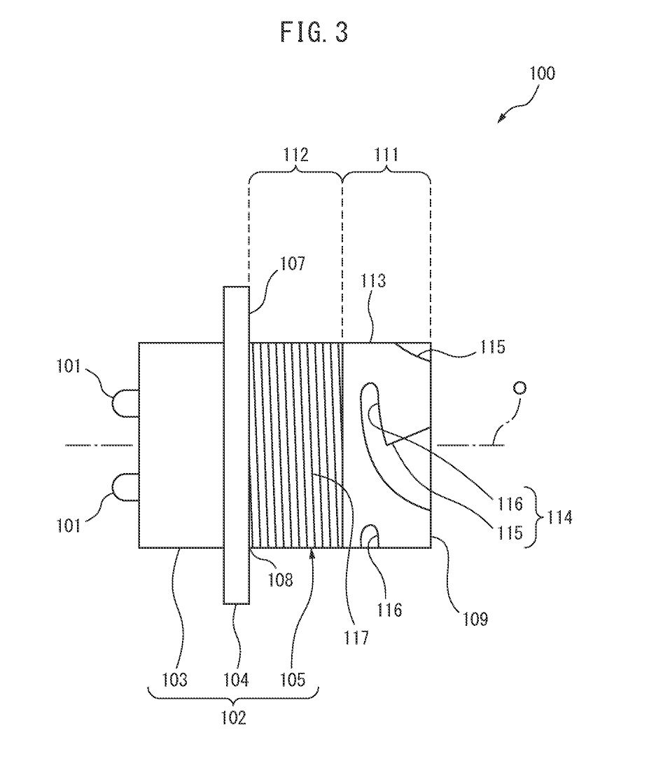

Next, referring to FIGS. 2 and 3, a configuration of the electric connector 100 according to the embodiment will be described. In the following description, a connection direction denotes a direction for moving the electric connector 100 relative to another connector when the electric connector 100 is connected to another connector. The connection direction in the embodiment is indicated by dashed lines O in FIGS. 2 and 3.

A circumferential direction denotes a direction along a circumference around the connection direction O. A proximal side denotes a fixed side of the electric connector 100 to the electric motor 10, i.e., left side of FIG. 3. A distal side denotes a connection side of the electric connector 100 to another connector, i.e., right side of FIG. 3.

The electric connector 100 includes conductor pins 101 extending in the connection direction O; and a main body 102 that holds the conductor pin 101 inside thereof. In the embodiment, a total of four conductor pins 101 are supported by the main body 102.

The main body 102 includes an electric motor side fixed part 103 disposed on the proximal side; a base part 104 disposed on the distal side of the electric motor side fixed part 103; and a connection holding part 105 disposed on the distal side of the base part 104. The electric motor side fixed part 103, which is a cylindrical member extending in the connection direction O, is inserted into a hole (not illustrated) formed on the top surface 13 of the housing 11.

The base part 104 is a square member formed to extend outward from the electric motor side fixed part 103. In the base part 104, a total of four holes (not illustrated) are formed at positions corresponding to the conductor pins 101. The corresponding conductor pin 101 is inserted into each of these through-holes. A total of four holes 106 are formed at four corners of the base part 104. The electric connector 100 is connected to the housing 11 of the electric motor 10 via bolts inserted into the holes 106.

The connection holding part 105 is a cylindrical member extending in the connection direction O from a proximal end 108 disposed on a distal end surface 107 of the base part 104 to a distal end surface 109. In an internal space of the connection holding part 105, a distal end of each conductor pin 101 is exposed.

In the embodiment, the connection holding part 105 is sectionalized into two sections along the connection direction O. Specifically, the connection holding part 105 is sectionalized into a first section ill disposed on a distal side of the connection holding part 105, and a second section 112 disposed adjacent to the first section 111 on the proximal side of the connection holding part 105.

The first section 111 includes an engaging part corresponding only to a push-on lock type. At the first section 111, the connection holding part 105 can be connected to another connector by push-on locking. Specifically, in the first section 111, grooves 114 are formed as the engaging part corresponding to the push-on lock type. Each groove 114, which is formed to be concaved inward from an outer surface 113 of the first section 111, extends from the distal end surface 109 of the connection holding part 105 toward the proximal side.

More specifically, each groove 114 includes a connection direction groove (moving direction groove) 115 extending in the connection direction O from the distal end surface 109 of the connection holding part 105 toward the proximal side; and a circumferential direction groove 116 extending from a proximal end of the connection direction groove 115 in a circumferential direction. In the embodiment, the connection direction groove 115 is formed so that the width of the connection direction groove 115 is reduced as extending from the distal end surface 109 of the connection holding part 105 toward the proximal side.

On the other hand, the second section 112 includes an engaging part corresponding only to a screw type. At the second section 112, the connection holding part 105 can be connected to another connector by screwing. Specifically, On an outer surface of the second section 112, a male thread 117 is formed as the engaging part corresponding to the screw type so as to helically extend in the connection direction. A start point of a distal side of the male thread 117 is disposed at the proximal end of the first section 111.

Thus, in the electric connector 100 according to the embodiment, the connection holding part 105 is sectionalized along the connection direction O into the first section 111 connectable to another connector by push-on locking and the second section 112 connectable to another connector by screwing. As a result, the electric connector 100 can be connected to both connectors of the push-on lock type and the screw type. This will be described below.

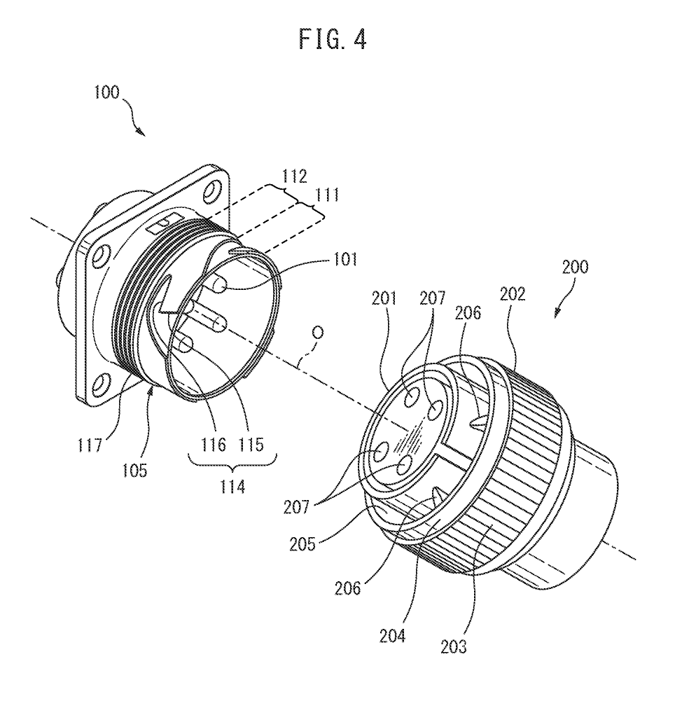

First, referring to FIG. 4, connection of the electric connector 100 according to the embodiment to a counterpart connector 200 by push-on locking will be described. The counterpart connector 200 includes a plug part 201 extending in the connection direction O, and an annular gripping part 202 disposed outside of the plug part 201.

The plug part 201 is a cylindrical member having a diameter slightly smaller than an inner diameter of the connection holding part 105. In the plug part 201, a total of four conductive holes 207 are formed corresponding to the conductor pins 101 of the electric connector 100.

The gripping part 202 is attached to the plug part 201 to be rotatable in a circumferential direction. A slip stopper part 203 is formed into a concave-convex shape on an outer surface 204 of the gripping part 202. On the other hand, on an inner surface 205 of the gripping part 202, projections 206 are formed to movably project inward from the inner surface 205. The projections 206 are disposed at positions corresponding to distal side openings of the connection direction groove 115.

The gripping part 202 is urged counterclockwise when seen from the electric connector 100 by a spring (not illustrated) attached to an inside of the gripping part 202. When a user rotates the gripping part 202 clockwise when seen from the electric connector 100 by a predetermined angle, the gripping part 202 receives a urging force from the spring in response to the angle. Then, when the user releases the gripping part 202, the gripping part 202 is rotated, by the urging force, counterclockwise in the circumferential direction when seen from the electric connector 100 to return to its initial position.

When connecting the electric connector 100 to the counterpart connector 200, the user positions the electric connector 100 with respect to the connector 200 so as to insert the conductor pins 101 of the electric connector 100 into the conductive holes 207 of the counterpart connector 200. Then, in a state where the gripping part 202 is rotated clockwise when seen from the electric connector 100, the user positions the projections 206 formed in the gripping part 202 of the connector 200 at the distal side openings of the connection direction groove 115 formed in the connection holding part 105 of the electric connector 100.

Then, the user pushes the counterpart connector 200 toward the proximal side of the electric connector 100 in the connection direction, and releases the gripping part 202. The projections 206 relatively slide in the connection direction groove 115 with engaging a side wall of the connection direction groove 115 disposed on one side of the circumferential direction. With this operation, the conductor pins 101 of the electric connector 100 are inserted deep into the conductive holes 207 of the counterpart connector 200 to electrically connect the electric connector 100 to the connector 200.

When the user pushes the counterpart connector 200 further toward the proximal side of the electric connector 100, each projection 206 reaches an area of the groove 114 where the circumferential direction groove 116 is formed. Then, the engagement between the projection 206 and the side wall of the connection direction groove 115 is released, and the gripping part 202 is rotated counterclockwise when seen from the electric connector 100 by the urging force of the spring.

At this time, each projection 206 slides in the circumferential direction groove 116. As a result, each projection 206 engages the distal side wall of the circumferential direction groove 116, thereby preventing the electric connector 100 from disengaging from the counterpart connector 200. Thus, the electric connection between the electric connector 100 and the connector 200 is held by the electric connector 100 engaging the connector 200 by push-on locking.

Thus, according to the embodiment, only by pushing the electric connector 100 into the counterpart connector 200 in the connection direction, the user can easily connect the electric connector 100 to the connector 200 by push-on locking. After the electric connector 100 has been connected to the connector 200, the outer surface 113 of the first section 111 and the inner surface 205 of the gripping part 202 come into surface-contact with each other. Accordingly, sealing performance can be secured in the internal space of the connection holding part 105.

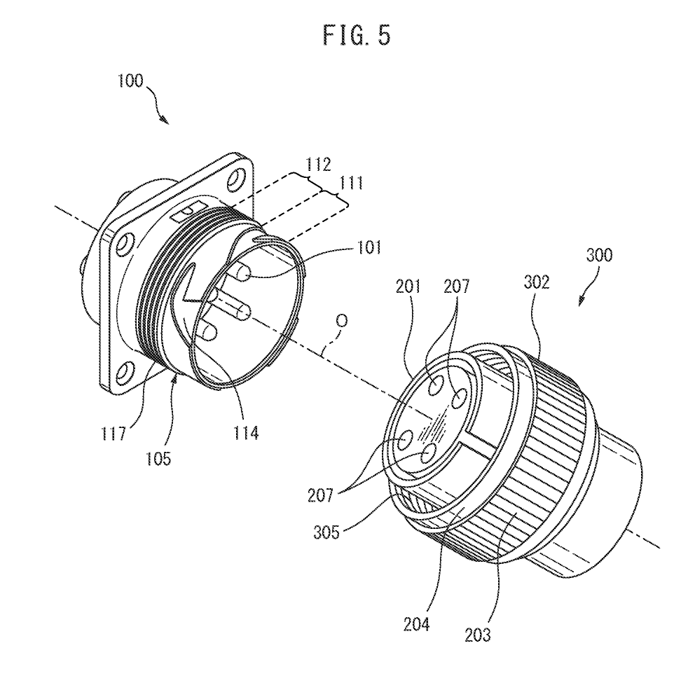

Next, referring to FIG. 5, connection of the electric connector 100 of the embodiment to a counterpart connector 300 by screwing will be described. Members similar to those of the aforementioned embodiment will be denoted by the same reference numerals, and detailed description will be omitted.

The counterpart connector 300 includes a plug part 201 including conductive holes 207, and an annular gripping part 302 disposed outside the plug part 201. The gripping part 302 is rotatably attached to the plug part 201. A slip stopper part 203 is formed on an outer surface 204 of the gripping part 302. On the other hand, a female thread 305 is formed in an inner surface of the gripping part 302.

When connecting the electric connector 100 to the counterpart connector 300, the user positions the electric connector 100 with respect to the connector 300 so as to insert the conductor pins 101 of the electric connector 100 into the conductive holes 207 of the counterpart connector 300. Then, the user positions the griping part 302 of the connector 300 at the distal end of the second section 112 of the connection holding part 105, and rotates the gripping part 302 counterclockwise when seen from the electric connector 100.

Then, the male thread 117 formed in the second section 112 is engaged with the female thread 305 formed in the gripping part 302. As the user rotates the gripping part 302, the conductor pins 101 of the electric connector 100 are inserted deep into the conductive holes 207 of the counterpart connector 300 to electrically connect the electric connector 100 to the connector 300.

Accordingly, the electric connection between the electric connector 100 and the connector 300 is held by screwing the electric connector 100 to the connector 300. Thus, according to the embodiment, the electric connector 100 can be connected to the connector 300 by screwing. Naturally, in this state, the male thread 117 and the female thread 305 are closely engaged with each other. As a result, sealing performance can be secured in the internal space of the connection holding part 105.

According to the embodiment, the electric connector 100 can be easily connected to both of the connectors of the push-on lock type and screw type while the sealed state is maintained in the electric connector 100. As a result, when the electric motor 10 is connected to an external device such as a power source, there is no need to change the counterpart connector connected to the external device, and thus, costs and work for replacing the electric motor 10 can be reduced.

In addition, requests for simplifying wiring work and shortening work time of the electric motor 10 can be met. Waterproof property of the electric connector 100 can be secured since the internal space of the electric connector 100 is sealed when the electric connector 100 is connected to other connectors.

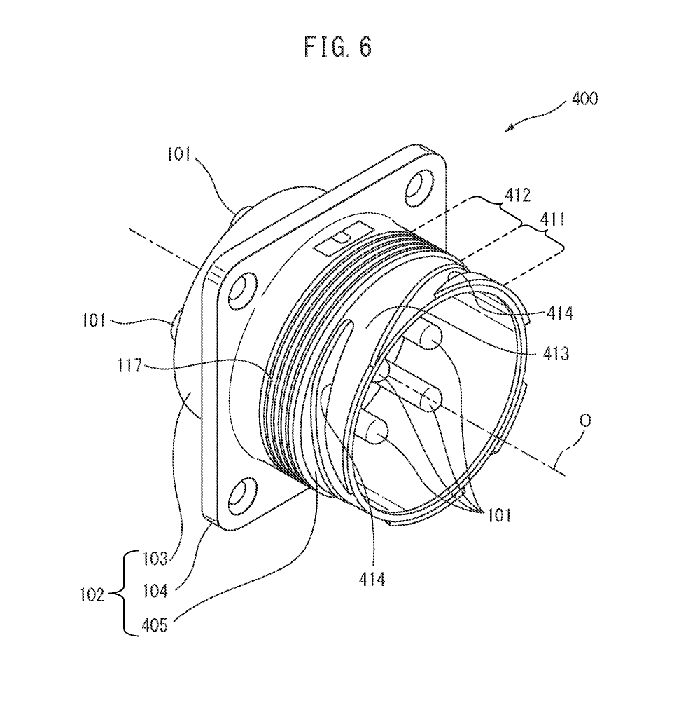

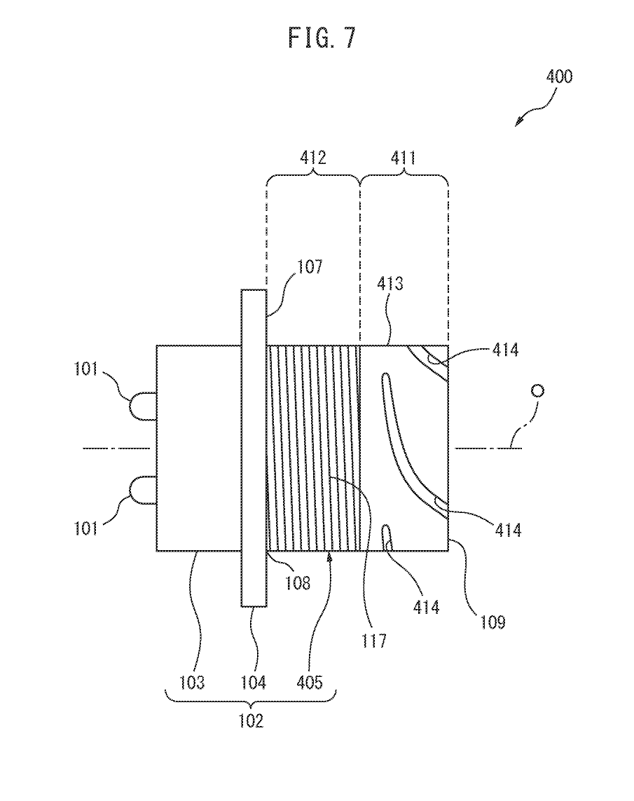

Next, referring to FIGS. 6 and 7, a configuration of an electric connector 400 according to another embodiment will be described. Members similar to those of the aforementioned embodiment will be denoted by the same reference numerals, and detailed description will be omitted.

Similar to the aforementioned embodiment, the electric connector 400 is fixed on a housing 11 of an electric motor 10. The electric connector 400 includes conductor pins 101 and a main body 102. The main body 102 includes an electric motor side fixed part 103, a base part 104, and a connection holding part 405.

The connection holding part 405 is sectionalized into two sections along the connection direction O. Specifically, the connection holding part 405 is sectionalized into a first section 411 disposed on a distal side of the connection holding part 405, and a second section 412 disposed adjacent to the first section 411 on the proximal side of the connection holding part 405.

In the embodiment, the first section 411 includes an engaging part corresponding only to a bayonet lock type. At the first section 411, the connection holding part 405 can be connected to another connector by bayonet locking. Specifically, in the first section 411, grooves 414 are formed as the engaging part corresponding to the bayonet lock type. Each of the grooves 414, which is formed concaved inward from an outer surface 413 of the first section 411, extends in a circumferential direction so as to be curved as extending from a distal end surface 109 of the connection holding part 405 toward the proximal side.

On the other hand, at the second section 412, the connection holding part 405 can be connected to another connector by screwing. Specifically, a male thread 117 is formed in an outer surface of the second section 412.

Thus, in the electric connector 400 according to the embodiment, the connection holding part 405 is sectionalized along the connection direction O into the first section 411 connectable to another connector by bayonet locking and the second section 412 connectable to another connector by screwing. As a result, the electric connector 400 can be connected to both connectors of the bayonet lock type and the screw type.

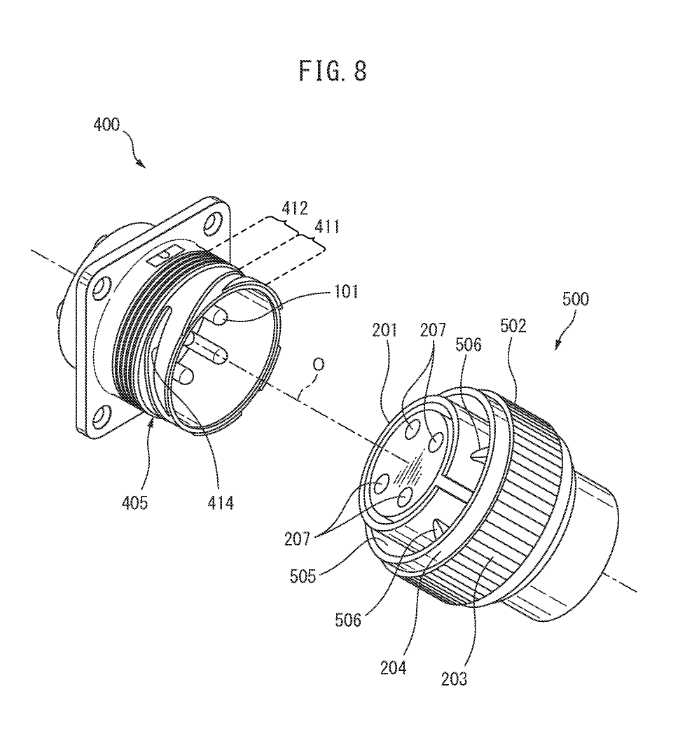

Next, referring to FIG. 8, connection of the electric connector 400 of the embodiment to a counterpart connector 500 by bayonet locking will be described. The counterpart connector 500 includes a plug part 201 including conductive holes 207, and an annular gripping part 502 disposed outside the plug part 201.

The gripping part 502 is attached to the plug part 201 to be rotatable in a circumferential direction. A slip stopper part 203 is formed on an outer surface 204 of the gripping part 502. On the other hand, on an inner surface 505 of the gripping part 502, projections 506 are formed to project inward from the inner surface 505. Each projection 506 is disposed at a position corresponding to distal side openings of the grooves 414.

When connecting the electric connector 400 to the counterpart connector 500, the user positions the projections 506 formed in the gripping part 502 of the connector 500 at the distal side openings of the grooves 414 formed in the connection holding part 405 of the electric connector 400.

Then, the user rotates the gripping part 502 counterclockwise when seen from the electric connector 400. Then, each projection 506 relatively slides in the groove 414 and engages corresponding groove 414. With this operation, the counterpart connector 500 is pushed toward the proximal side in the connection direction relative to the electric connector 400. The conductor pins 101 of the electric connector 400 are inserted into conductive holes 207 of the counterpart connector 500, and the electric connector 400 is electrically connected to the connector 500.

Thus, according to the embodiment, the user can easily connect the electric connector 400 to the connector 500 of the bayonet lock type. After the electric connector 400 has been connected to the connector 500, the outer surface 413 of the first section 411 and an inner surface 205 of the gripping part 502 come into surface-contact with each other. Accordingly, sealing performance can be secured in the internal space of the connection holding part 405.

A method for connecting the electric connector 400 of the embodiment to a connector of a screw type is similar to that of the embodiment described above referring to FIG. 5. Therefore a detailed description will be omitted.

As described above, according to the embodiment, the electric connector 400 can be easily connected to both of the connectors of the bayonet lock type and screw type while the sealed state is maintained in the electric connector 400.

The embodiment has been directed to the case where the second section connectable to another connector by screwing is disposed on the proximal side of the connection holding part. Without being limited to this, however, the second section connectable by screwing may be disposed on the distal side of the connection holding part.

The embodiment has been directed to the case where the connection holding part is sectionalized into the two sections in the connection direction. Without being limited to this, however, the connection holding part may be sectionalized into three or more sections in the connection direction. In such a case, each of the sections is configured to include an engaging part corresponding to one selected from types of engagement different from one another, i.e., a push-on-type lock, bayonet-type lock, screw-type lock, and other type of locks.

As described above, according to the present invention, when the electric connector is connected to another connector, a connected state with another connector can be maintained by each of the plurality of the types of engagement. As a result, when the electric motor is connected to an external device such as a power source, there is no need to change the counterpart connector connected to the external device, and thus, costs and work for replacing the electric motor can be reduced. Furthermore, wiring work and work time of the electric motor can be simplified and shortened. When the electric connector has been connected to another connector, the internal space of the electric connector can be sealed. As a result, waterproof property of the electric connector can be secured.

The present invention has been described by way of embodiments. However, the embodiments described above do not limit the invention specified within the appended claims. All the combinations of the features described in the embodiments are not essential to solution of the invention. It is obvious to those skilled in the art that various changes or improvements can be made of the embodiments described above. As is obvious from the appended claims, such changes or improvements may be included in the technical scope of the invention.

1. An electric connector comprising a connection holding part configured to hold a connection state with another connector by each of a plurality of types of engagement, wherein,
the connection holding part includes a plurality of sections sectionalized along a relative moving direction for electrically connecting the electric connector to another connector,
each of the plurality of sections includes an engaging part corresponding to one of the types of engagement different from one another.

2. The electric connector according to claim 1, wherein,
the connection holding part is sectionalized into a first section disposed on a distal side of the connection holding part and a second section disposed adjacent to the first section on a proximal side of the connection holding part,
the first section includes a groove extending from a distal end surface of the connection holding part on its outer surface,
the second section includes a helically extending male thread on its outer surface.

3. The electric connector according to claim 2, wherein the first section is connectable to a connector including an inward projection by bayonet locking.

4. The electric connector according to claim 2, wherein the first section is connectable to a connector including a movable projection by push-on locking.

5. The electric connector according to claim 2, wherein the second section is connectable to a connector including a female thread on an inner surface by screwing.

6. The electric connector according to claim 2, wherein a plurality of the grooves are formed at equal intervals in a circumferential direction of the connection holding part.

7. The electric connector according to claim 2, wherein the groove includes:
a moving direction groove extending in the relative moving direction from the distal end surface of the connection holding part toward the proximal side of the connection holding part; and
a circumferential direction groove extending from a proximal end of the moving direction groove in a circumferential direction.

8. The electric connector according to claim 7, wherein the width of the moving direction groove is reduced as extending from the distal end surface of the connection holding part toward the proximal side of the connection holding part.

9. An electric motor comprising the electric connector according to claim 1.
